(19) United States
(12) Patent Application Publication
(10) Pub. No.: US 2017/0320286 A1
(43) Pub. Date: Nov. 9, 2017

(54) Low Profile Stable Attachment System

(71) Applicant: Richard Allan Carlson, Murrieta, CA (US)

(72) Inventor: Richard Allan Carlson, Murrieta, CA (US)

(73) Assignee: Synergy Art and Design, Murrieta, CA (US)

(21) Appl. No.: 15/149,703

(22) Filed: May 9, 2016

(51) Int. Cl. B32B 3/26; B32B 5/26; A41D 1/04; B32B 7/08; A45F 3/04

(52) U.S. Cl. CPC B32B 3/266; B32B 7/08; A45F 3/04; A41D 1/04; B32B 5/26; B32B 2250/20; B32B 2437/00

(57) ABSTRACT

The present invention relates to a personal load carrying system including a load carrying fabric with a plurality of triangular cut-outs configured to accept various pockets, pouches or accessories.

### BACKGROUND

It has long been a long standing issue to find the best equipment and method for carrying personal protection and tactical equipment into field; this applies equally to both military and civilian law enforcement personnel. The challenge is to supply the personnel with all the necessary equipment to successfully carry out a mission without unnecessarily encumbering their mobility and speed.

The current state of the art load system, used by primarily by the United States, British and Allied militaries, is a system called out by the acronym MOLLE (pronounced molly, as in the English female name) which stands for Modular Lightweight Load-carrying Equipment. The system uses a plurality of horizontal heavy-duty nylon webbing sections stitched onto the outside surface of the device, the webbing sections, referred to in the industry as PALS, or Pouch Attachment Ladder System. The PALS webbing allows for the attachment of a plurality of pouches and accessories designed with straps that may be threaded under, or woven into, the attached webbing and then closed with a snap attached at the end of the strap.

This MOLLE system allows personnel to attach equipment and supplies to their regular carrying equipment, such as, a rucksack, tactical vest or body armor. It allows for increased carrying capacity, facilitates easy access to pouches attached to the outside surface, and allows personnel to add or remove pouches or pockets as dictated by the mission. The MOLLE system also saves the general organization money where one basic pack, tactical vest or body armor unit can be modified for use by myriad personnel, operating in different capacities and theaters.

One issue with the MOLLE system is that, while the attachment of equipment and accessories to PALS webbing is fairly secure, it is not necessarily tight or rigid. This can lead to shifting of the pouches or equipment while the user is in motion. The shifting load may allow the pouches to lose orientation, making accessibility an issue, and in the case where the pouch contains heavy items like, water, food, explosives or ammunition, the shifting may create an oscillating dynamic load that is uncomfortable to user, and ultimately to lead to increased user fatigue.

What is needed is a personal load system that works with existing MOLLE components, that provides a more secure attachment, while reducing movement, and dynamic loading when the user is in motion.

### SUMMARY OF THE INVENTION

The present invention is an improved personal load carrying system the utilizes a series of triangular openings, arranged in a row matrix, cut out of a resilient fabric load carrying panel which is attached to the outside surface of a personal load device, such as, a rucksack, backpack, tactical vest or body armor. The improved load carrying system, may include pouches or pockets configured to securely hold items such as, but not limited to, boxed ammunition, ammunition magazines, grenades, explosives, knives, tools, flashlights, recording devices, water and food, such as, MREs (meals ready to eat). It is contemplated that any number of accessories, tools or equipment may be configured to securely attach into the series of triangular opening without the use of a separate pouch or pocket.

The triangular openings of the present invention take advantage of the physical properties of a triangle, which will generally maintain its shape or configuration when loaded. When a vertical force, such as a loaded strap, is evenly applied to the base of the triangular cut-out, the force is divided in half and distributed up each side of the triangle to the pinnacle where it is focused back into a single vertical force vector. In the instance where the base of the triangle is un-evenly loaded, one of the sides of the triangle will carry a disproportionate amount of the load however, since the force is refocused back into a single vector, the triangular opening will maintain its shape. Whereas, the rectangular opening created between two parallel webbing strips in the MOLLE system will only maintain its rectangular shape when the load is even and exactly perpendicular to horizontal axis of the webbing. If the load applied to the webbing is uneven, the rectangular opening is prone to distortion. In one embodiment of the present invention or personal load carrying system, the sides of the triangular openings or cut-outs meet at a distinct point. In another embodiment of the present invention there is a radius formed at each side junction. It is contemplated that the junction radius will evenly distribute directional forces at the junction and thereby reducing the likelihood of deformation or tearing.

Many rucksacks, backpacks or similar devices include a plurality of slots cut into the exterior fabric or into carrier panels attached to the surface of the device. The slots are designed to accept straps or cords, allowing the user to carrying various items like a sleeping pad or outerwear on the outside of the device. However, it is necessary to leave enough play, or to cut the slots wide enough, to allow insertion of the strap with a buckle or snap which is used for closure. The play in the strap allows the loads to shift or move when in use. A triangular opening in the load carrying fabric allows the strap to be the same size or a similar size to the base of the triangle, which eliminates play and the resulting movement. One additional benefit of a triangular opening is, while the base of the triangle accepts the strap, the upper portion of the triangle is free to allow easy access for fingers to grasp the end of a strap during assembly or to allow a buckle or snap to freely pass through the opening.

The load carrying fabric may be a light-weight high-tensile fabric that will reduce the weight when compared to a similar nylon webbing MOLLE system. The load carrying fabric may also be a conventional fabric having a laminated backing such polypropylene to prevent tearing or distortion. In other embodiments of the present invention, the load carrying fabric may be more than one panel of fabric laminated together or the load carrying fabric may be more than one panel of fabric placed together, having an alternating bias, and then laminated.

In one embodiment, the triangular openings or cutouts may be die-cut from the load carrying fabric. In yet another embodiment it is contemplated that the triangular openings or cutouts may be formed using water jet or laser cutting.

These and other features and advantages of the disclosure will be set forth and will become more fully apparent in the detailed description that follows and in the appended claims. The features and advantages may be realized and obtained by the instruments and combinations particularly pointed out in the appended claims. Furthermore, the features and advantages of the disclosure may be learned by the practice of the methods or will be obvious from the description, as set for herein.

### BRIEF DESCRIPTION OF THE DRAWINGS

The following description of the embodiments can be understood in light of the Figures, which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals in different drawings represent the same element, and thus their descriptions may be omitted.

FIG. 1 is one embodiment of the prior art or MOLLE load carrying garment,

FIGS. 2A and 2B represent strap openings found in the prior art,

FIG. 3A is one embodiment of the triangular opening of the present invention,

FIG. 3B is one embodiment of the triangular opening with a load strap,

FIG. 3C is one embodiment of the triangular opening with a load strap having a snap,

FIG. 4 is one embodiment of the carrier fabric panel with triangular openings,

FIG. 5 is one embodiment of the carrier fabric system configured as a tactical vest,

FIG. 6 is one embodiment of the carrier fabric system configured as a rucksack,

### DETAILED DESCRIPTION OF THE INVENTION

For the purposes of promoting an understanding of the principles in accordance with the disclosure, reference will be made to the embodiments illustrated in the drawings and specific language will be used to describe the same. It will nevertheless be understood that no limitation of the scope of the disclosures is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

As used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and the grammatical equivalents thereof are inclusive or open-ended terms that do not exclude additional, unrecited elements of method processes.

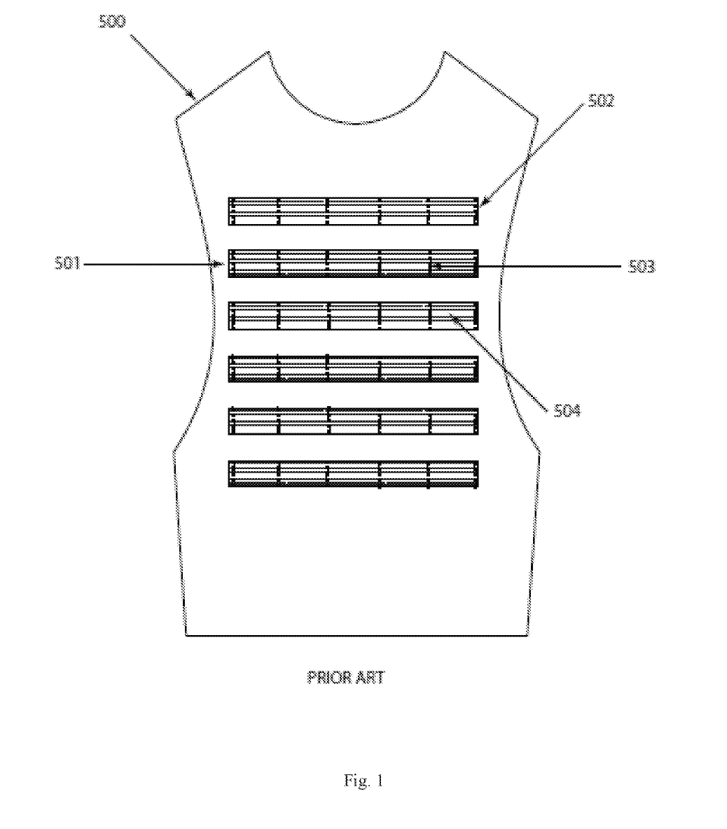

FIG. 1 is a representation of a tactical vest 500 having a plurality of nylon webbing strips 501 attached to the outside of the vest 500 in a horizontal configuration. The nylon webbing is sewn to the vest at the free ends 502 and stitched again at regular intervals 503 to form attachment loops 504. Pouches and bags can be attached to the outside of vest 500 by passing a strap under at least one of the plurality of webbing strips 501 in the attachment loop 504 formed between the stitched portions.

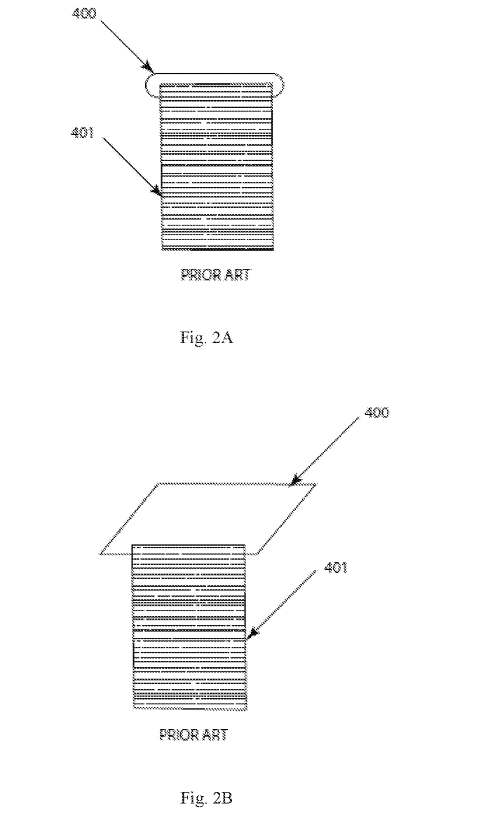

FIG. 2A represents a strap slot or opening 400 of the prior art with a strap 401 passed through the opening. As shown, strap 401 is narrower than the opening 400, providing a loose or sloppy fit.

FIG. 2B shows a rectangular opening 400 of the prior art subject to uneven loading by strap 401. This represents normal distortion in the space between consecutive attachment loops 504, as shown in FIG. 1, or in a configuration where slot 400 is a large opening to provide access for snaps or buckles (not shown) attached to strap 401.

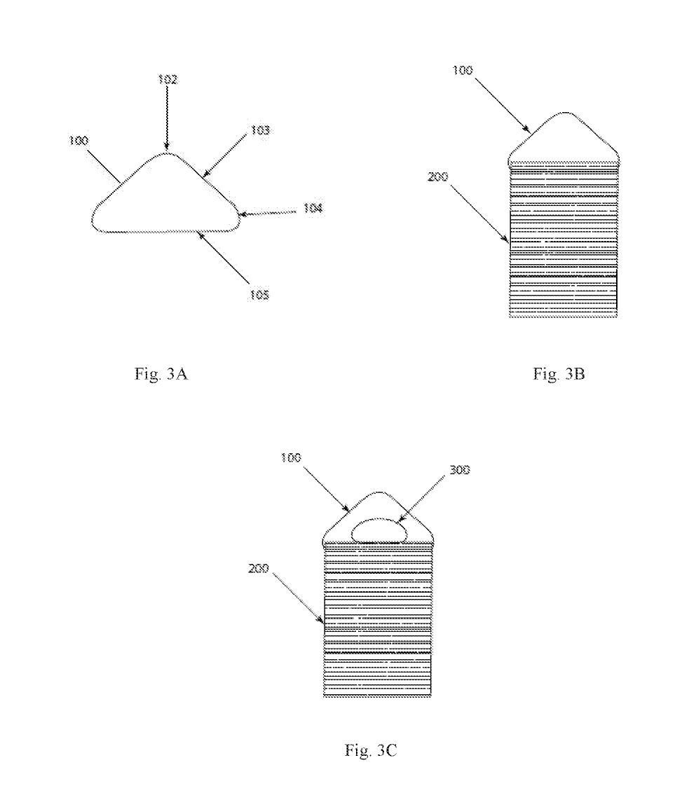

FIG. 3A is the triangular opening 100 of the present invention having a base portion 105, junctions having a radius 104, sides 103 and top or pinnacle 102.

FIG. 3B shows triangular opening 100 with a strap or webbing 200 having the same width as the base 105 (FIG. 1) of the opening 100. This arrangement proving a stable secure fit between opening 100 and strap 200.

FIG. 3C shows triangular opening 100 and strap 200 having a snap top 300. As shown, when strap 200 is in the base 105 of opening 100, the snap 300 readily fits through the upper portion of the triangular opening 100.

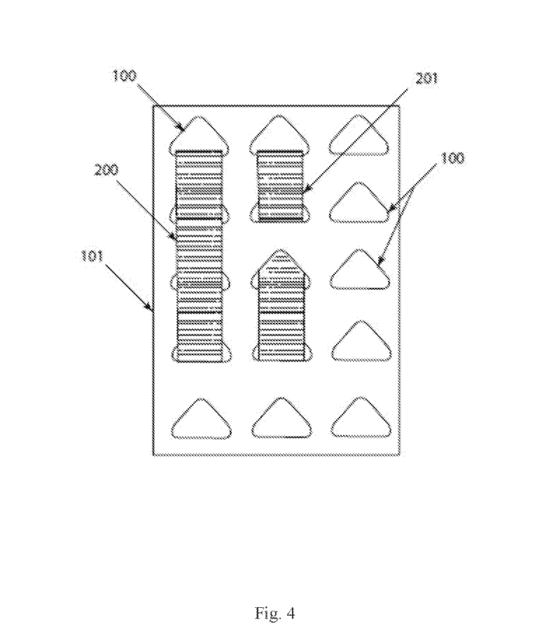

FIG. 4 is a load carrying fabric panel 101 having a plurality of triangular openings 100 arranged in a grid pattern. The strap 200 is configured in an overlapping pattern over a plurality of openings 100, whereas, strap 201 is configured in a woven or inter-locking pattern through a plurality of openings 100. The overlapping pattern of strap 200 is quicker and easier for a user to configure. The woven pattern of strap 201 will provide a more rigid or secure fit.

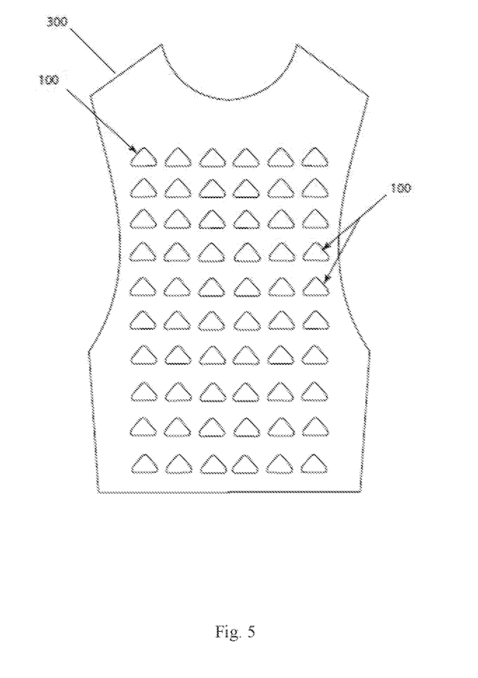

FIG. 5 is a representation of a tactical vest 300 having a fabric load carrying panel with triangular openings 100 forming a grid pattern. The panel may be bonded or sewn around the perimeter to the outside surface of vest 300 or may include sewn, fabric welded or bonded junctions in the margins between openings 100.

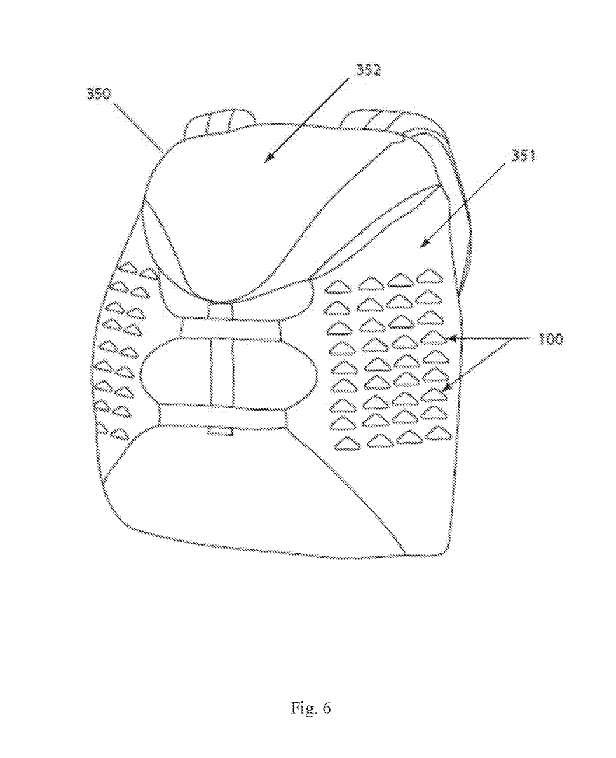

FIG. 6 is a representation of a rucksack or backpack 350 having side panels 351 with a load carrying fabric panel attached, the panel includes triangular openings 100 forming a grid pattern used to attach additional pouches, pockets or equipment. It is understood and contemplated to attach an additional panel to the top flap 352 of pack 350.

1. A personal load carrying system comprising;
a) a load carrying multilayer fabric panel.
b) a plurality of triangular suspension cut-outs.

2. The invention of claim 1 wherein the multilayer fabric panel is comprised of at least 1 ply of fabric stitched to another ply of fabric.

3. The invention of claim wherein at least 1 ply of fabric of the multilayer fabric panel is laminated or reinforced.

4. The invention of claim 1 wherein the ply of the multilayer fabric panel that faces outwards contains a laminated or reinforced fabric.

5. The invention of claim 1 wherein the outward facing sheet of the multilayer fabric panel is stitched to the other panel(s) vertically, from top to bottom, every 3″ along the x-axis.

6. The invention of claim 1 wherein the outward facing sheet of the multilayer fabric panel's perimeter is stitched to another ply of fabric.

7. The invention of claim 1 wherein the triangle shape is cut-out of the outward facing sheet of the multilayer fabric panel using a laser cutter, water jet or dye.

8. The invention of claim 1 wherein the triangle shape is
1″ wide by ½″ tall, + or − 1/16″

9. The invention of claim 1 wherein the triangle point is facing up.

10. The invention of claim 1 wherein the triangle bottom is facing down.

11. The invention of claim 1 wherein each of the triangle's 3 corners are curved.
